(19) United States
(12) Patent Application Publication
(10) Pub. No.: US 2009/0084235 A1
(43) Pub. Date: Apr. 2, 2009

(54) JETTING APPARATUS AND ORIGIN CORRECTION METHOD THEREFOR

(75) Inventors: Akira KATA, Toyama-shi (JP); Naotsugu TERASAKI, Shimoniikawa-gun (JP); Takuya AOKI, Kurobe-shi (JP)

Correspondence Address: Capitol IP, PLLC, 113 S. Columbus St., Suite 311, Alexandria, VA, 22314, US

(73) Assignee: SUGINO MACHINE LIMITED, Uozu-shi (JP)

(21) Appl. No.: 12/238,482

(22) Filed: Sep. 26, 2008

(30) Foreign Application Priority Data
Sep. 28, 2007 (JP) 2007-254305

(51) Int. Cl. B26D 5/00

(52) U.S. Cl. 83/72

(57) ABSTRACT

An origin correction method of matching a set processing top point with a machine top point of a high pressure jet in a jetting apparatus having a two-axis angle control for controlling tilt and -pivot angles other than a three-axis control consisting of X, Y, Z-axes includes: a jet radial-runout measurement process of measuring a position of the jet passing through an XY-plane; a jet radial-runout correction process of calculating an error at the processing top point and correcting radial runout of the jet; a jet top-point variation measurement process of changing the tilt angle and measuring two positions, where the jet passes through the XY-plane; and a jet top-point variation correction process of calculating an error at the processing top point from position data of the two positions and correcting a deviation of the processing top point.

This application claims the foreign priority benefit under 35 U.S.C. §119 of Japanese Patent Application No. 2007-254305 filed on Sep. 28, 2007, the disclosure of which is incorporated herein by reference.

### BACKGROUND OF THE INVENTION

1. Field of the Invention

The present invention relates to a jetting apparatus and an origin correction method therefor, and particularly, to a jetting apparatus and an origin correction method for the apparatus that can ensure stable processing accuracy.

2. Description of the Related Art

Water jetting by a jetting apparatus sprays pressurized water at a speed of not less than twice of a sound speed and performs processing. Therefore, because the water jetting can perform shaping such as cutting while avoiding an influence on a property of a work without generating heat, it is suitable for processing a new material, without selecting a material, and the application of the water jetting has been broadened to various fields.

Furthermore, in recent years it becomes required to shorten a processing time, to process a complicated three-dimensional shape, and to achieve high accuracy; a five-axis control processing machine is now sold where a tilt control and a pivot control are added to a conventional three-axis control.

However, compared to the conventional three-axis control, when performing controls of not less than five axes accompanied with an axis rotation control, if there exists any of a nozzle-jet-outlet positional displacement and a nozzle center-axis tilt (angularity), there occurs an error at a position of a processing top point, depending on a rotation angle when a control axis is rotated (tilted or pivoted). Therefore, the five-axis control cannot be considered same as a simple three-axis control (see claims and FIG. 1 in Japanese Patent Laid-Open Publication No. H02-72000). Accordingly, when performing the controls of not less than five axes, there exists a problem that it becomes burdensome to adjust a machine origin position of each axis and that there occurs an accuracy deviation for every operator.

On the other hand, it is difficult to narrow a tolerance range of a nozzle and to ensure accuracy, and there exists a fear that the accuracy varies every time when the nozzle is changed. Therefore, because processing accuracy of the nozzle has to be measured every time when the nozzle is changed, a correction parameter has to be input, based on the measured value of the nozzle, and then a machine origin has to be corrected, there exists a problem that a measurement error occurs and an operation time is longer.

Consequently, there are needs for a jetting apparatus that can ensure stable jetting accuracy, and for an origin correction method for the apparatus.

### SUMMARY OF THE INVENTION

A first aspect of the present invention is an origin correction method of matching a set processing top point with a machine top point of a sprayed high pressure jet (Jet flow) in a jetting apparatus for spraying the jet on a work from a nozzle, the apparatus having a two-axis angle control for controlling a tilt angle and a pivot angle other than a three-axis control consisting of an X-axis and a Y-axis orthogonalized with each other and a Z-axis of a spray axis line, the method comprising of: a jet radial-runout measurement process of measuring a position of the jet passing through an XY-plane including the machine top point in a state of spraying the jet in a Z-axis direction; a jet radial-runout correction process of calculating an error at the processing top point, based on a deviation between position dada obtained by the jet radial-runout measurement process and the set processing top point, and correcting radial runout of the jet; a jet top-point variation measurement process of changing the tilt angle and measuring two positions, where the jet passes through the XY-plane, in a state of the jet being tilted and sprayed with respect to the Z-axis direction by the angle control; and a jet top-point variation correction process of calculating an error at the processing top point of the jet from position data of the two positions and correcting a deviation of the processing top point.

Thus, the invention sets a processing-top-point parameter from the position data, based on the jet, thereby makes the jet a reference, and corrects a machine origin. The “processing top point” in the jetting apparatus means a top point as a setting value theoretically set by setting a top point parameter (parameter for setting the top point) before a processing start and the like.

That is, by making a jet (pass position and orbit) a reference, and correcting a machine origin, it becomes possible to eliminate an influence of a nozzle size tolerance; therefore, it is possible to maintain jetting accuracy without enhancing a nozzle quality and nozzle size accuracy more than they are conventionally needed.

Furthermore, because a parameter adjustment matched with the spray state of a nozzle finally assembled is performed, it becomes possible to eliminate the influences of various errors and to stably ensure constant processing accuracy without a variation.

Meanwhile, the “machine top point” means a collision point (jet point) where a jet sprayed from a nozzle collides with a work. Furthermore, a distance between the nozzle and the machine top point is preferably set adequately in its value by considering a processing condition, and preferably eliminates an error so that a jet is converged on a constant top point, not depending on a nozzle tilt angle.

A second aspect of the invention is the origin correction method in the jetting apparatus described in the first aspect, and in the radial runout measurement process a position where a center axis of the jet passes through the XY-plane including the machine top point is measured with a transmission laser sensor.

In accordance with the second aspect of the invention, a position where the center axis of the jet passes through the XY-plane including the machine top point is measured with a transmission laser sensor, and thereby because it is possible to detect an edge (outer peripheral point) of the jet, it becomes easy to accurately measure the position of sprayed jet with no contact.

A third aspect of the invention is the origin correction method in the jetting apparatus described in any one of the first aspect and the second aspect; the two-axis angle control consists of the nozzle pivot angle control in the Z-axis and the nozzle tilt angle control in any one of the X-axis and the Y-axis; and in the radial runout measurement process, the nozzle is rotated by the pivot angle control, and a position of the jet is measured in directions along the X-axis and the Y-axis.

In accordance with the third aspect of the invention, the nozzle is rotated by the pivot angle control, and the position of the jet is measured in the directions along the X-axis and the Y-axis, and thereby it is possible to measure deviations of the processing top point in the X and Y directions with respect to the machine top point in the Z-axis.

A fourth aspect of the invention is a jetting apparatus which has a two-axis angle control for controlling a tilt angle and a pivot angle other than a three-axis control consisting of an X-axis and a Y-axis orthogonalized with each other and a Z-axis of a spray axis line, and sprays a high pressure jet on a work from a nozzle, the apparatus comprising: an origin correction controller configured to match a set processing top point with a machine top point of the jet sprayed; and an optical size-measurement device configured to be provided free-rotatably with respect to a table of the jetting apparatus and to measure a pass position of the jet, wherein the origin correction controller performs: a jet radial-runout measurement process of measuring a position of the jet passing through an XY-plane including the machine top point in a state of spraying the jet in a Z-axis direction; a jet radial-runout correction process of calculating an error at the processing top point, based on a deviation between position dada obtained by the jet radial-runout measurement process and the processing top point, and correcting radial runout of the jet; a jet top-point variation measurement process of changing the tilt angle and measuring two positions, where the jet passes through the X-Y plane, in a state of the jet being tilted and sprayed with respect to the Z-axis direction by the angle control; and a jet top-point variation correction process of calculating an error at the processing top point of the jet from position data of the two positions and correcting a deviation of the processing top point.

In accordance with the fourth aspect of the invention, the processing-top-point parameter is set from the measured position data, based on the jet, thereby makes the position of the jet a reference, and it is possible to correct a machine origin and to eliminate the influence of a nozzle size tolerance. Therefore, it becomes possible to maintain jetting accuracy without enhancing a nozzle quality and nozzle size accuracy more than they are conventionally needed.

Furthermore, because a parameter adjustment matched with the spray state of a nozzle finally assembled is performed, it becomes possible to eliminate the influences of various errors and to stably ensure constant processing accuracy without a variation.

In accordance with the jetting apparatus and the origin correction method in the jetting apparatus according to the invention, it is possible to ensure stable jetting accuracy.

### BRIEF DESCRIPTION OF THE DRAWINGS

FIGS. 1A and 1B are perspective views illustrating a configuration of a jetting apparatus according to an embodiment of the present invention; FIG. 1A shows a general configuration; and FIG. 1B shows a partial enlarged front view of a laser sensor unit in FIG. 1A.

FIG. 2 is a side section view schematically showing a configuration of a nozzle according to the embodiment.

FIG. 3 is a front view illustrating a machine-top-point setting process of according to the embodiment.

FIGS. 4A, 4B, and 4C are drawings illustrating a jet (Jet flow) radial-runout measurement process; FIG. 4A shows a state of the laser sensor being made parallel to an X-axis; FIG. 4B shows a state of the laser sensor being made parallel to a Y-axis; and FIG. 4C is a plan view illustrating a state of a deviation of the jet in a processing top point.

FIGS. 5A and 5B are drawings illustrating a jet-top-point measurement process and show a state of the laser sensor being made parallel to the Y-axis; FIG. 5A is a perspective view; and FIG. 5B is a plan view illustrating a state of a deviation of the jet (Jet flow) in the processing top point.

FIGS. 6A and 6B are drawings illustrating the jet top-point measurement process and show a state of the laser sensor being made parallel to the X-axis; FIG. 6A is a perspective view; and FIG. 6B is a plan view illustrating a state of a deviation of the jet in the processing top point.

### BEST MODE FOR CARRYING OUT THE INVENTION

Here will be described an embodiment of the present invention in detail with reference to drawings as needed.

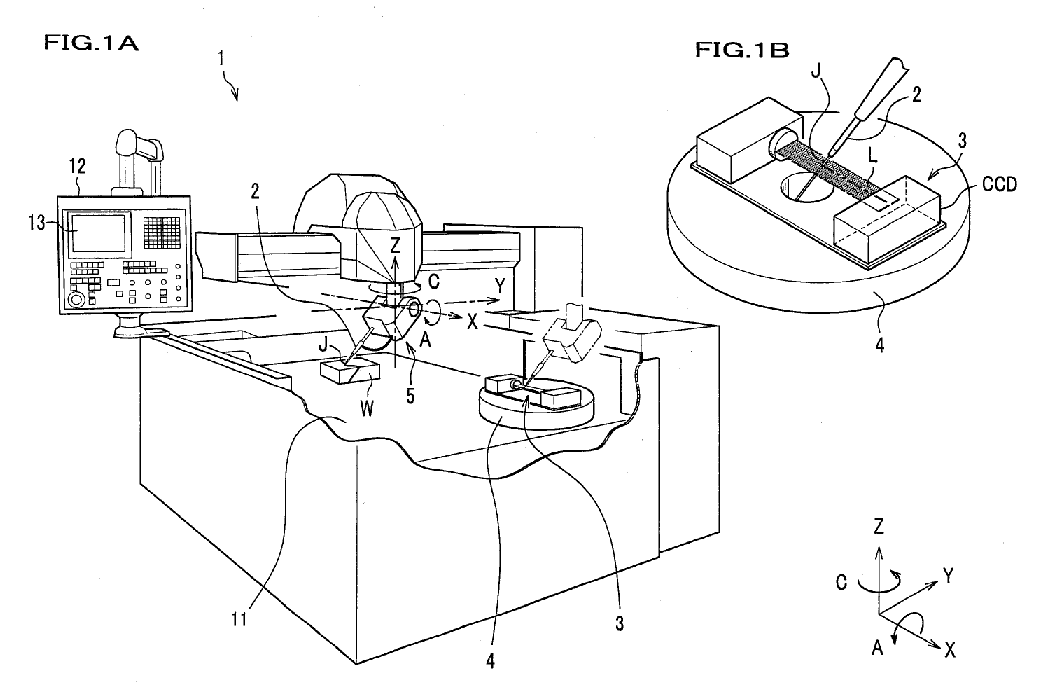

A jetting apparatus 1 according to the embodiment of the invention comprises, as shown in FIG. 1A: a two-axis angle control (A axis, C axis) for controlling a tilt angle and a pivot angle other than a three-axis control consisting of an X-axis and a Y-axis orthogonalized with each other and a Z-axis of a spray axis line; a nozzle 2 for spraying a high pressure fluid (for example, water) (jet J) of a high pressure jet flow on a work W; a high pressure fluid (for example, water) supply device (not shown) for supplying the high pressure water to the nozzle 2; an origin correction controller (not shown) for matching a processing top point stored and set in a control unit with a machine top point of the jet J sprayed; and a laser sensor 3 of an optical size-measurement device placed on a rotation table 4; and an operation panel 12 operated by an operator.

Meanwhile, in the embodiment, as an example of the jetting apparatus 1, although a five-axis-control high-pressure-water cutting apparatus is described where the work W is placed, a table 11 is fixed, and the nozzle 2 is moved, the apparatus 1 is not limited thereto; even a jetting apparatus of a table moving type and comprising angle controls not less than three axes can be applied as the apparatus 1.

Although there exist various ways of taking an Z-axis, a Y-axis, and a Z-axis forming three axes, in the embodiment, as shown in FIGS. 1A and 1B, a right-left direction seen from an operator not shown (operation panel 12) is noted as the X-axis; a front-rear direction, the Y-axis; and an up-down direction (height direction), the Z-axis.

The nozzle 2 is, as shown in FIG. 1A, attached to a processing head 5. Then the processing head 5 is supported by the three axes of the X-axis, the Y-axis, and the Z-axis; and by the two rotation axes of the A-axis and the C-axis rotating around the X-axis and the Z-axis, making them center axes, respectively.

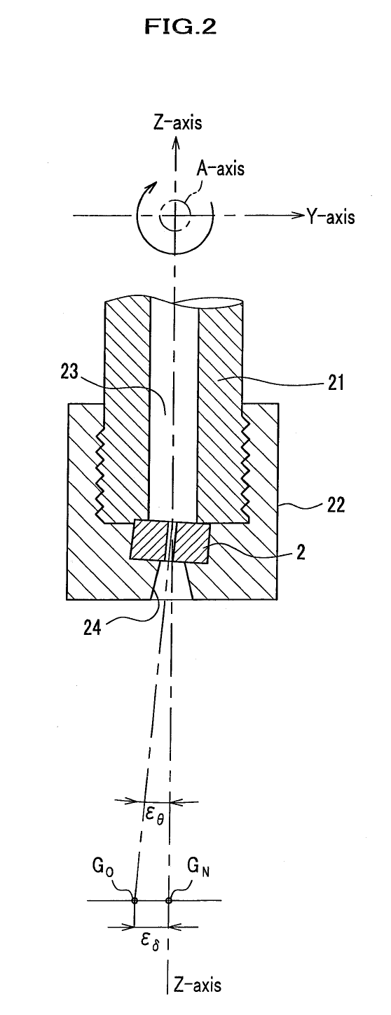

The nozzle 2 is, as shown in FIG. 2, attached to a nozzle adaptor 21 and fixed by a nut 22. Then high pressure water is supplied from a flow passage 23 and sprayed from a jet outlet 24 as the jet J (FIG. 1A).

As exaggeratedly shown in FIG. 2, with respect to the nozzle 2, a position eccentricity of the jet outlet 24 and a tilt ε_{θ} with respect to the Z-axis direction are actually tolerated within a tolerance in product accuracy. Therefore, there exists an error ε_{θ} (deviation) between a spray position G_{N} in a case of an ideal nozzle in a state of the nozzle 2 being attached and a position of a machine top point Go of the jet J actually sprayed from the nozzle 2.

Here, the machine top point Go exists on an extended line of the jet J actually sprayed from the nozzle 2; whereas, with respect to a processing top point G_{J}, a top point parameter (parameter for setting a top point) is set, and then a position of the top point G_{J} is defined.

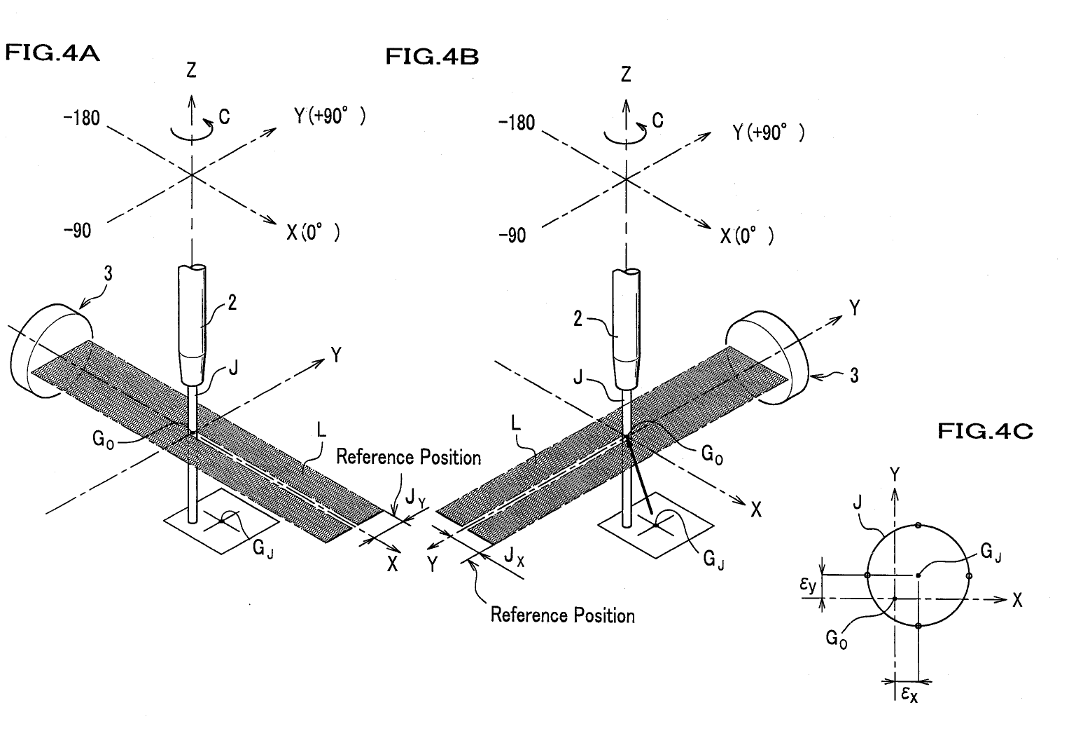

Therefore, although the processing top point G_{J} before a change of the nozzle 2 is adjusted at a position (not shown) where the top point G_{J} matches the machine top point Go, the top point G_{J} is positioned at a position where the top point G_{J} is displaced from a present machine top point Go because of the change of the nozzle 2 to another one (see FIG. 4).

As the laser sensor 3, as shown in FIG. 1B, for example, a transmission size-measurement device (laser sensor) can be used; thereby it is possible to radiate laser L to the jet J sprayed, to capture a shade portion formed by being blocked by the jet J by means of a CCD (Charge Coupled Device) image sensor, and to measure an outer diameter size and passing position coordinates of the jet J, and thereby to display them in a monitor 13 (FIG. 1A) and/or to memorize them in a memory not shown.

Meanwhile the laser sensor 3 is not limited to a CCD image sensor system; for example, a scan system is also available which scans a laser beam, calculates a distance from a time of a shade portion formed by the jet J, and obtains position data.

Thus in accordance with the embodiment, the measurement is performed by the transmission laser sensor, and thereby it is possible to detect an edge (outer peripheral point) of the jet J; therefore, it becomes possible to accurately measure the position of the jet J with no contact.

The origin correction controller includes a central processing unit, which consists of a control unit and an operation unit not shown, and a memory, controls a five-axis movement and a high pressure jet supply device (not shown), and operates as follows. Then it is possible to match the processing top point G_{J} with the machine top point Go of sprayed high pressure jet J (see FIG. 2).

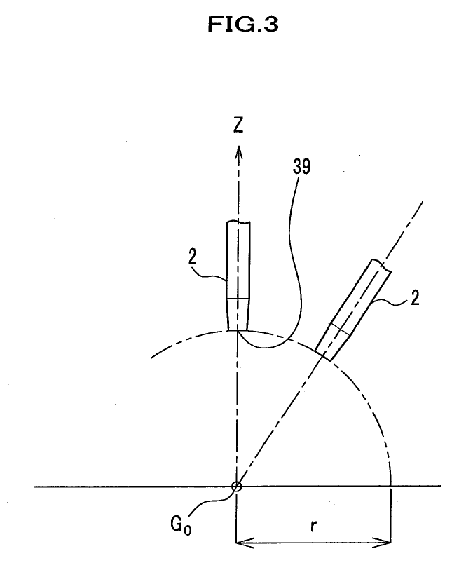

An operation of the origin correction controller and each process will be described mainly with reference to FIGS. 3 to 6B.

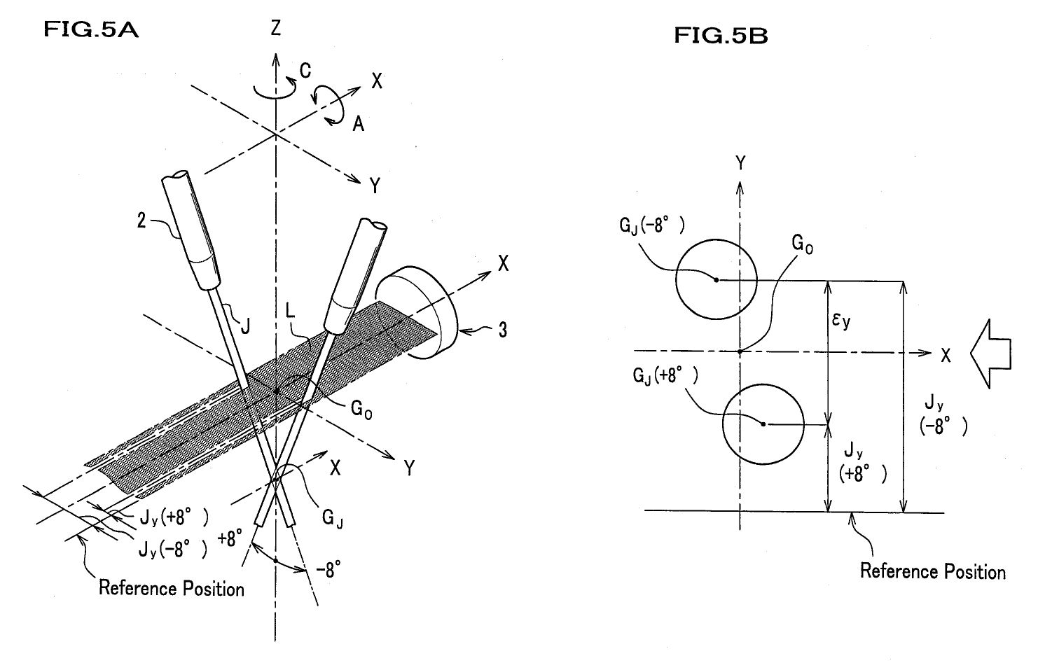

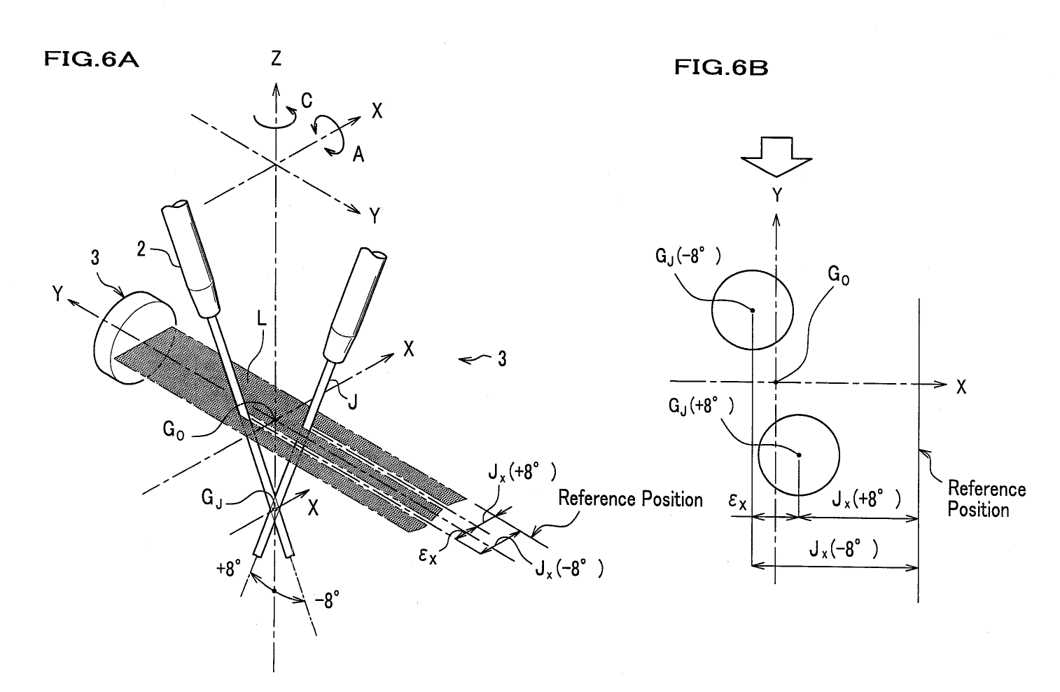

The origin correction controller is configured to perform: a machine-top-point setting process of checking a position of the nozzle 2 and setting in advance the machine top point Go consisting of a machine origin (FIG. 3); a jet radial-runout measurement process of measuring a position of the jet J, a jet flow, by the laser sensor 3 in a state of spraying the jet J in the Z-axis direction, wherein at the position the jet J passes through an XY-plane including the machine top point Go (FIGS. 4A-4C); a jet radial-runout correction process of calculating an error at the processing top point G_{J}, based on a deviation between position dada obtained by the jet radial-runout measurement process and the processing top point G_{J}, and correcting radial runout of the jet J; a jet top-point variation measurement process of changing a tilt angle of the A-axis (FIG. 1A) and measuring two positions, where the jet J passes through the XY-plane, by the laser sensor 3 in a state of the jet J being tilted (−8 degrees and +8 degrees making the processing top point G_{J} a center) and sprayed with respect to the Z-axis direction by the angle control of the A-axis (FIGS. 5A to 6B); and a jet top-point variation correction process of calculating a difference between position data of the two positions and correcting a variation of the processing top point G_{J} of the jet J.

Firstly, in order to match positions of the nozzle 2 and the laser sensor 3, when an operator pushes a measurement start button arranged on the operation panel 12, the laser sensor 3 appears, as shown in FIG. 1A, at a predetermined measurement position (right back of the table 11 in the embodiment) set on the table 11 by a movement device not shown. Meanwhile it is also possible to fixedly install the laser sensor 3 and to move the nozzle 2 to its position.

In the machine-top-point setting process the nozzle 2 is moved to a measurable point above the laser sensor 3 (see FIG. 1B), the Z-axis (FIGS. 1A and 1B) descends to a radiation plane of the laser L, a position of a nozzle top 39 is checked, the position is made a reference, and the machine top point Go defined from a machine origin is set in advance. Then the position of the machine top point Go is set at a point away from the nozzle top 39 by a predetermined distance r and is memorized in a memory not shown.

In the jet radial-runout measurement process, as shown in FIG. 4A, the jet J is sprayed from the nozzle 2 in a state of the laser sensor 3 being arranged in parallel to the X-axis, and a position is measured where the jet J passes through the XY-plane including the machine top point Go.

Specifically, the C-axis is rotated from −180 degrees to −90 degrees, −0 degree, and +90 degrees for every 90 degrees, and under the four conditions, on the laser sensor 3 are measured center positions Jy (coordinates on the XY-plane) of the jet J, respectively. Then from the measured data of the center positions Jy of the jet J, it is possible to obtain a deviation ε_{y} (ε_{y1}, ε_{y2}, ε_{y3}, ε_{y4}) in the Y-axis direction at each of the positions Jy.

Here, ε_{y1}, ε_{y2}, ε_{y3}, ε_{y4} indicate the deviation ε_{y} in cases of the C-axis being rotated to −180 degrees, −90 degrees, −0 degree, and +90 degrees, respectively (see FIG. 4C). Furthermore, the center positions Jy of the jet J mean distances thereto from a reference position (outer edge of a laser L width) within a measurement range of the laser sensor 3 in the Y-axis direction.

Similarly further in the jet radial-runout measurement process, as shown in FIG. 4B, the jet J is sprayed from the nozzle 2 in a state of the laser sensor 3 being arranged in parallel to the Y-axis, and center positions Jx (coordinates on the XY-plane) are measured where the jet J passes through the XY-plane including the machine top point Go. Then from the measured data of the center positions Jx of the jet J, it is possible to obtain a deviation εₓ (εₓ₁, εₓ₂, εₓ₃, εₓ₄) in the X-axis direction at each of the positions Jx.

Here, εₓ₁, εₓ₂, εₓ₃, εₓ₄ indicate the deviation εₓ in cases of the C-axis being rotated to −180 degrees, −90 degrees, −0 degree, and +90 degrees, respectively (see FIG. 4C). Furthermore, the center positions Jx of the jet J mean distances thereto from a reference position (outer edge of a laser L width) within a measurement range of the laser sensor 3 in the X-axis direction.

Thus by rotating the C-axis for every 90 degrees and measuring the center positions Jx, Jy of the jet J, it is possible to obtain the deviations εₓ,ε_{y} of the processing top point G_{J} with respect to the machine top point Go around the C-axis.

Meanwhile, in the embodiment, although the laser sensor 3 is rotated so as to be in parallel to the X and Y-axes, two laser sensors may be arranged so as to be in parallel to the X and Y-axes, respectively.

In accordance with the jet radial-runout correction process, deviations (errors) at the processing top point G_{J} are obtained from the deviations εₓ,ε_{y} on the X and Y-axes obtained in the jet radial-runout measurement process, and a correction parameter is changed so that the top point G_{J} matches the processing top point Go (see FIG. 4B).

At this time, when a center variation (deviations in the X-axis and Y-axis directions) is within a predetermined range value (for example, ±0.05), the jet radial-runout correction proceeds to the next process. On the other hand, when the center variation is not within the range value, the correction parameter is changed, and the jet radial-runout measurement process and the jet radial-runout correction process are repeated.

Thus by repeating the jet radial-runout measurement process and the jet radial-runout correction process and making the deviations within a predetermined range value, it is possible to ensure stable processing accuracy.

In the jet top-point-variation measurement process, as shown in FIG. 5A, the A-axis is tilted by −8 degrees and +8 degrees in a state of the laser sensor 3 being arranged in parallel to the Y-axis, and each of the positions (coordinates) Jy (−8 degrees), Jy (+8 degrees) of the jet J is measured where the jet J passes through the XY-plane on the radiation plane of the laser L radiated from the laser sensor 3.

Meanwhile, in the jet top-point-variation measurement process, a backlash of the C-axis is preferably removed in advance. Therefore, before the A-axis is tilted, for example, the C-axis is rotated by five degrees and then returned, and thus the backlash of the C-axis in the rotation direction is removed. Furthermore, although the A-axis is tilted by −8 degrees and +8 degrees, its tilt angle is not limited thereto; although the angle is preferably set as large as possible, it is possible to appropriately define the angle according to such a specification of a machine.

From the positions (coordinates) Jy (−8 degrees), Jy (+8 degrees) of the jet J thus measured, as shown in FIG. 5B, it is possible to obtain the deviation (variation width) ε_{y} in the processing top point G_{J}.

Furthermore, in the jet top-point-variation measurement process, as shown in FIG. 6A, the rotation table 4 (FIGS. 1A and 1B) is rotated by 90 degrees, the A-axis is tilted by −8 degrees and +8 degrees in a state of the laser sensor 3 being arranged in parallel to the X-axis, and each of the positions (coordinates) Jx (−8 degrees), Jx (+8 degrees) of the jet J is measured where the jet J passes through the XY-plane on the radiation plane of the laser L radiated from the laser sensor 3.

From the positions (coordinates) Jx (−8 degrees), Jx (+8 degrees) of the jet J thus measured, as shown in FIG. 6B, it is possible to obtain the deviation (variation width) εₓ in the processing top point G_{J}.

In accordance with the jet top-point-variation correction process, differences between the deviations εₓ,ε_{y} (variation width) on the X and Y-axes obtained in the jet top-point-variation measurement process and a theoretical variation width from −8 degrees to +8 degrees are calculated, deviations (errors) at the processing top point G_{J} are obtained, and a correction parameter is changed so that the top point G_{J} matches the machine top point Go.

At this time, when a center variation (deviations in the X and Y-directions) is within a predetermined range value (for example, ±0.05), the jet top-point-variation correction process proceeds to the next process. On the other hand, when the center variation is not within the range value, the correction parameter is changed, and the jet top-point-variation measurement process and the jet top-point-variation correction process are repeated.

Thus by repeating the jet top-point-variation measurement process and the jet top-point-variation correction process and making the deviations within a predetermined range value, it is possible to ensure stable processing accuracy. Thus setting the origin correction is completed.

Thus in accordance with the origin correction method of the embodiment, based on position data of the jet J (jet flow) measured, a processing-top-point parameter is set from the data, thereby the jet J is made a reference, and a machine origin is corrected.

That is, by making a position, where the jet J passes, a reference, and by resetting the processing-top-point parameter and correcting so that the processing top point Gj matches the machine top point Go, it is possible to eliminate the influence of a nozzle size tolerance; therefore, it becomes possible to maintain jetting accuracy without enhancing a nozzle quality and nozzle size accuracy more than they are conventionally needed.

Furthermore, because a parameter adjustment matched with a spray state of a nozzle finally assembled is performed, it becomes possible to eliminate the influences of various errors and to stably ensure constant processing accuracy without a variation.

Thus although the embodiment of the present invention has been described, the invention is not limited thereto, and may be appropriately changed and practiced.

For example, in the embodiment, although the A-axis and the C-axis are controlled in rotation as a two-axis angle control for controlling a tilt angle and a pivot angle, the embodiment is not limited thereto; the A-axis and a B-axis (rotation axis making the Y-axis direction a rotation center) may be controlled in rotation. In this case, with respect to the B-axis similarly to the A-axis, by tilting the B-axis by −8 degrees and +8 degrees and obtaining radial runout in the processing top point G_{J}, it is possible to correct the origin position.

In accordance with the jet radial-runout measurement process in the embodiment, from a viewpoint of operation processing, although the C-axis may be rotated from −180 degrees to −90 degrees, 0 degree, and +90 degrees for every 90 degrees and the positions of the jet J are measured, the embodiment is not limited thereto; the C-axis may be rotated by an arbitrary angle as needed.

What is claimed is:

1. An origin correction method of matching a set processing top point with a machine top point of a sprayed high pressure jet in a jetting apparatus for spraying the jet on a work from a nozzle, the apparatus having a two-axis angle control for controlling a tilt angle and a-pivot angle other than a three-axis control consisting of an X-axis and a Y-axis orthogonalized with each other and a Z-axis of a spray axis line, the method comprising of:
a jet radial-runout measurement process of measuring a position of the jet passing through an XY-plane including the machine top point in a state of spraying the jet in a direction of the Z axis;
a jet radial-runout correction process of calculating an error at the processing top point, based on a deviation between position dada obtained by the jet radial-runout measurement process and the processing top point, and correcting radial runout of the jet;
a jet top-point variation measurement process of changing the tilt angle and measuring two positions, where the jet passes through the XY-plane, in a state of the jet being tilted and sprayed with respect to the direction of the Z axis by the angle control; and
a jet top-point variation correction process of calculating an error at the processing top point of the jet from position data of the two positions and correcting a variation of the processing top point.

2. The origin correction method according to claim 1, wherein the jet radial-runout measurement process is configured to measure a position, where a center axis of the jet passes through the XY-plane including the machine top point, with a transmission laser sensor.

3. The origin correction method according to claim 1, wherein the two-axis angle control consists of the pivot angle control of the nozzle in the Z-axis and the tilt angle control of the nozzle in any one of the X-axis and the Y-axis, and wherein the jet radial-runout measurement process is configured to rotate the nozzle by the pivot angle control and to measure a position of the jet in directions along the X-axis and the Y-axis.

4. The origin correction method according to claim 2, wherein the two-axis angle control consists of the pivot angle control of the nozzle in the Z-axis and the tilt angle control of the nozzle in any one of the X-axis and the Y-axis, and wherein the jet radial-runout measurement process is configured to rotate the nozzle by the pivot angle control and to measure a position of the jet in directions along the X-axis and the Y-axis.

5. A jetting apparatus having a two-axis angle control configured to control a tilt angle and a pivot angle other than a three-axis control consisting of an X-axis and a Y-axis orthogonalized with each other and a Z-axis of a spray axis line, and spraying a high pressure jet on a work from a nozzle, the apparatus comprising:
an origin correction controller configured to match a set processing top point with a machine top point of the jet sprayed; and
an optical size-measurement device configured to measure a pass position of the jet,
wherein the origin correction controller is configured to perform:
a jet radial-runout measurement process of measuring a position of the jet passing through an XY-plane including the machine top point in a state of spraying the jet in a direction of the Z axis;
a jet radial-runout correction process of calculating an error at the processing top point, based on a deviation between position dada obtained by the jet radial-runout measurement process and the processing top point, and correcting radial runout of the jet;
a jet top-point variation measurement process of changing the tilt angle and measuring two positions, where the jet passes through the X-Y plane, in a state of the jet being tilted and sprayed with respect to the direction of the Z axis by the angle control; and
a jet top-point variation correction process of calculating an error at the processing top point of the jet from position data of the two positions and correcting a deviation of the processing top point.
